(19) United States
(12) Patent Application Publication
(10) Pub. No.: US 2010/0181772 A1
(43) Pub. Date: Jul. 22, 2010

(54) Pendular Generator

(76) Inventor: Türketap Õztürk, Izmir (TR)

Correspondence Address: AKERMAN SENTERFITT, P.O. BOX 3188, WEST PALM BEACH, FL, 33402-3188, US

(21) Appl. No.: 12/663,200

(22) PCT Filed: Jun. 4, 2008
(86) PCT No.: PCT/TR08/00064

§ 371 Date: Dec. 4, 2009

(30) Foreign Application Priority Data
Jun. 5, 2007 (TR) 2007/03864

(51) Int. Cl. F03B 13/20; F15B 13/04; F15B 1/027

(52) U.S. Cl. 290/53; 91/418; 60/413; 60/325

(57) ABSTRACT

The present invention relates to a hydromechanical pendular generator generating electricity on vessels by making use of the energy of waves.

### FIELD OF INVENTION

The present invention relates to a hydromechanical pendular generator generating electricity on vessels by making use of the energy of waves.

### PRIOR ART

The gradually increasing energy requirement worldwide brings new researches to the agenda. The gradual increase of energy costs and the presence of environmental-friendly approaches have resulted in renewable energy sources which have been switched to worldwide, such sources including solar energy applications (photovoltaic panel), wind energy applications (wind turbine), and finally, the wave energy application, which actually is very novel.

The energy-generating systems on vessels by making use of renewable sources are very restricted nowadays and include photovoltaic panels, wind generators, and stream generators. The most crucial problems of said applications are associated with the lack of providing energy continuity, the fact that the area required for assembling such mechanisms on vessels reduces the utility area, and with their high costs. For instance, a system to generate energy from solar energy would require photovoltaic panels to be assembled on the vessel, resulting in a reduction of the general-purpose area on the vessel. Additionally, the lifespan of photovoltaic panels is 20 years and they cannot generate energy during nighttimes when no sun is available. Likewise, wind and stream generators fail in providing energy continuity either. It is obviously because winds and streams are not continuously available on/in sees, but waves are.

The international patent document WO 03066971 as a reference to the prior art discloses a system which is floatingly-placed on ocean and converts wave energy into electrical energy.

Another prior art document is the China patent CN 1386974, disclosing a generator which converts the energy of waves into electrical energy.

### BRIEF DESCRIPTION OF INVENTION

The objective of the present invention is to embody a pendular generator converting the energy of waves into electrical energy.

Another objective of the present invention is to embody a pendular generator which converts the wave energy into energy that is required for setting/lowering the sails, lifting the anchor, and for the sail control mechanisms.

### DETAILED DESCRIPTION OF INVENTION

The pendular generator according to the present invention embodied to achieve the objectives referred to hereinabove is illustrated in annexed figures, briefly described hereunder.

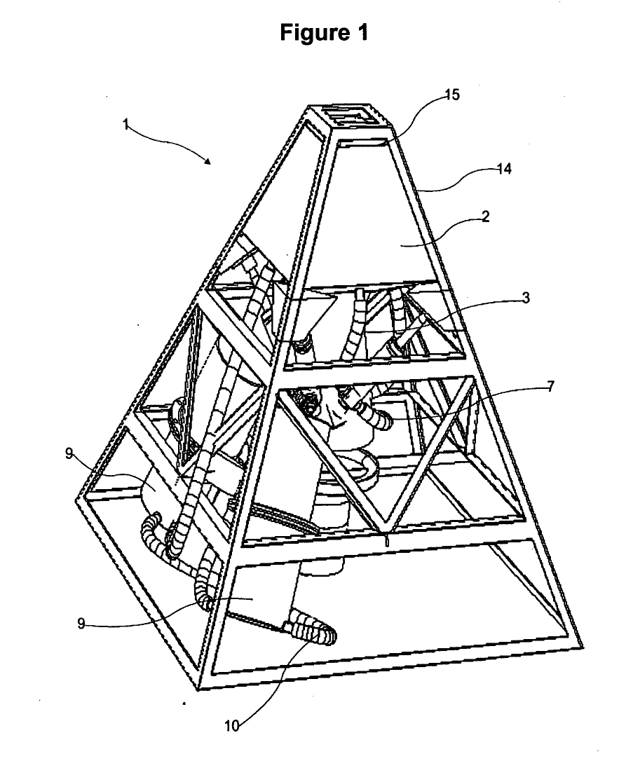

FIG. 1 is a perspective view of the pendular generator.

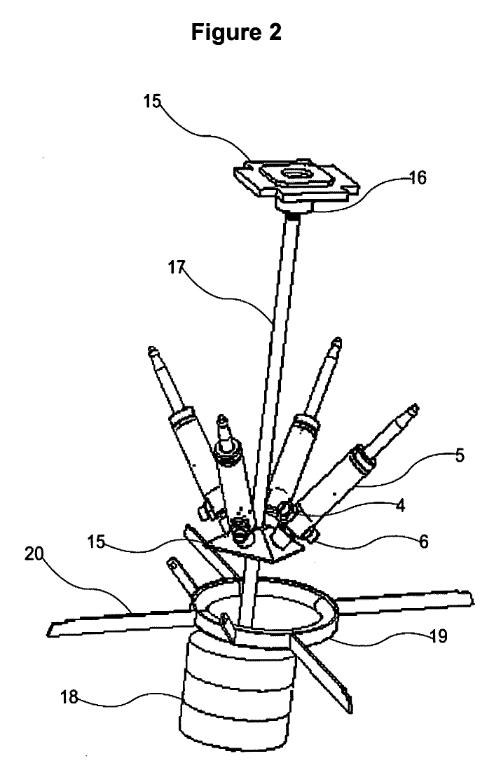

FIG. 2 is a perspective view of the pendular generator.

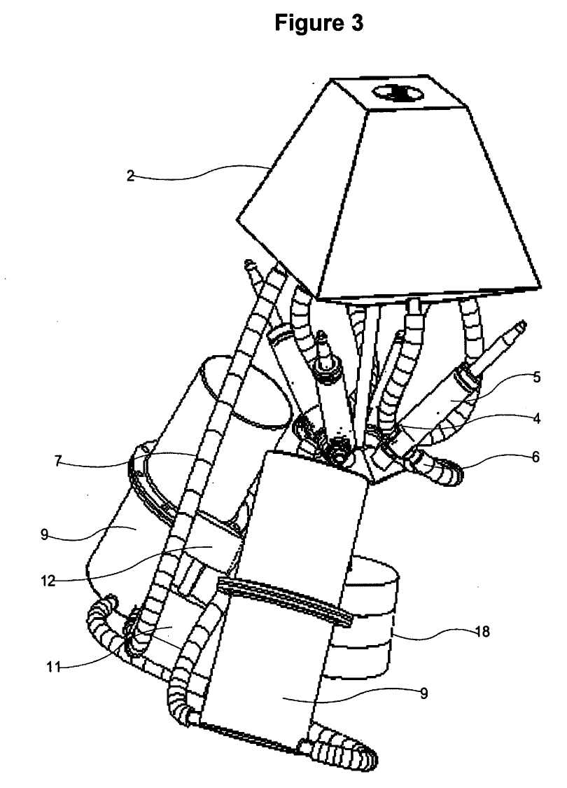

FIG. 3 is a perspective view of the pendular generator.

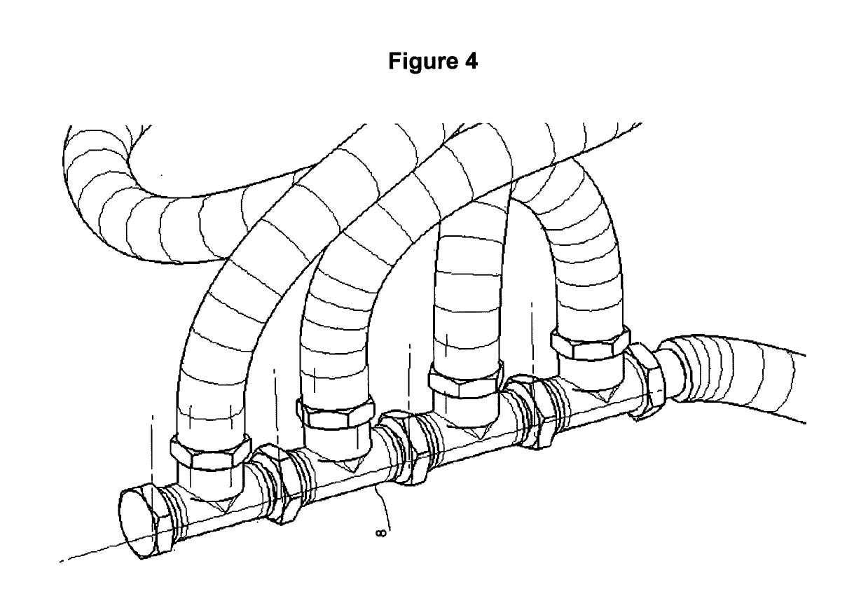

FIG. 4 is a perspective view of the pendular generator's collector.

The parts in said figures are individually enumerated as following.
1. Pendular generator
2. Reservoir
3. Inlet hose
4. Inlet control valve
5. Hydraulic cylinder
6. Outlet control valve
7. Outlet hose
8. Collector
9. Hydraulic accumulator
10. Proportional valve
11. Hydromotor
12. Dynamo
13. Return hose
14. Pyramidal body
15. Upper bracket
16. Spherical ball bearing
17. Pendulum rod
18. Pendulum weight
19. Safety ring
20. Rod bracket
21. Body bracket

The pendular generator (1) according to the present invention comprises most basically at least one reservoir (2) wherein the fluid is stored, an inlet hose (3) connecting the fluid into the hydraulic cylinder (5), an inlet control valve (4) providing a single-way flow, and an outlet control valve (6) provided on the outlet of the hydraulic cylinder (5) in order to provide a single-way flow.

It further comprises outlet hoses (7) connecting the fluid output from the hydraulic cylinders (5) into the collector (8), at least one hydraulic accumulator (9) storing the pressurized fluid coming from the collector (8), and at least one proportional valve (10) which opens once the fluid pressure reaches a certain level, and closes once it drops down to another certain level.

It also comprises at least one hydromotor (11) converting the fluid pressure into rotational motion, at least one dynamo converting the rotational motion into electrical energy, and at least one return hose (13) delivering the fluid output from the hydromotor (11) back to the reservoir (2).

It comprises at least one pyramidal body (14) used to mount the pendular generator (1), at least one upper bracket (15) mounted to the top of said pyramid, and a spherical ball bearing (16) placed in said upper bracket (15) to allow for angular deviation from the vertical axis.

It comprises at least one pendulum rod (17) connecting the pendulum weight (18) to the upper bracket (15), a safety ring (19) restricting the angle of oscillation, a rod bracket (20) connecting the piston rods of hydraulic cylinder (5) to the pendulum rod (17), and at least four body brackets (21) connecting the hydraulic cylinders (5) to the pyramidal body (14).

The pendulum weight (18) of the pendular generator (1) is biased to displace to the side the vessel is tipped, because of gravity. The system transmits this produced force to the hydraulic cylinder (5), which is mounted between the pendulum rod (17) and the body bracket (21) by means of spherical ball bearings (16). In the reverse movement of the piston of hydraulic cylinder (5), the fluid coming through the inlet hose (3) from the reservoir (2) passes through the inlet control valve (4) and fills the volume in front of the piston of hydraulic cylinder (5). In the forward displacement of the piston of said hydraulic cylinder (5), the fluid filling the front of the piston is compressed and passed through the outlet control valve (6) and delivered to the hydraulic accumulator (9) through the outlet hose (7). As long as the forth and back displacements of the hydraulic cylinder's (5) piston due to this swinging affect are maintained, the hydraulic accumulator (9) is charged with such pressurized fluid. The fluid outlet from the hydromotor (11) is returned to the reservoir (2) via the fluid return hose (13).

The pendular generator (1) may both use the positional energy emerging as a result of the changing position of the pendulum weight (18), and the kinetic energy difference occurring in the body of the pendulum weight (18) under the influence of the vessel's speed alteration to increase the fluid's pressure.

Since the pendular generator (1) produces a pressurized fluid, this hydraulic power may be utilized to activate the anchor lifting mechanism and the sail setting/lowering mechanism by connecting another circuit to the output of the hydraulic accumulator (9).

Very high pressures may be obtained and more power can be generated by increasing the size of the pendular generator (1), enhancing the pendulum weight (18), and reducing the piston radiuses.

1. A pendular generator comprising:
at least one reservoir wherein fluid is stored;
a hydraulic cylinder;
an inlet hose connecting the fluid to the hydraulic cylinder;
an inlet control valve providing a single-way flow; and
an outlet control valve provided on the outlet of the hydraulic cylinder's piston in order to provide a single-way flow.

2. The pendular generator according to claim 1, comprising outlet hoses connecting the fluid output from the hydraulic cylinders' piston into the collector, at least one hydraulic accumulator storing the pressurized fluid from the collector, and at least one proportional valve which opens once the fluid pressure reaches a certain level, and closes once it drops down to another certain level.

3. The pendular generator according to claim 1, comprising at least one hydromotor converting the fluid pressure into rotational motion, at least one dynamo converting the rotational motion into electrical energy, and at least one return hose delivering the fluid output from the hydromotor back to the reservoir.

4. The pendular generator according to claim 1, comprising at least one pyramidal body used to mount the pendular generator, at least one upper bracket mounted to the top of said pyramid, and a spherical ball bearing placed in said upper bracket to allow for angular deviation from the vertical axis.

5. The pendular generator according to claim 1, comprising at least one pendulum rod connecting the pendulum weight to the upper bracket, a safety ring restricting the angle of oscillation, a rod bracket connecting the pistons of hydraulic cylinder to the pendulum rod, and at least one body bracket connecting the hydraulic cylinder pistons to the pyramidal body.
